(19) United States
(12) Patent Application Publication
(10) Pub. No.: US 2003/0179413 A1
(43) Pub. Date: Sep. 25, 2003

(54) Identification card watermarking

(76) Inventors: Gary A. Lenz, Eden Prairie, MN (US); Gary M. Klinefelter, Eden Prairie, MN (US)

Correspondence Address: Brian D. Kaul, WESTMAN CHAMPLIN & KELLY, Suite 1600 - International Centre, 900 South Second Avenue, Minneapolis, MN, 55402-3319, US

(21) Appl. No.: 10/390,803

(22) Filed: Mar. 18, 2003

Related U.S. Application Data
(60) Provisional application No. 60/365,732, filed on Mar. 19, 2002.

(51) Int. Cl. G09C 5/00; B42D 15/00

(52) U.S. Cl. 358/3.28; 283/113; 380/55; 283/74

(57) ABSTRACT

In a method of processing a primary print job corresponding to a primary image using an identification card manufacturing system, a watermarked image is generated that includes a combination of the primary image and a watermark image. The watermark image includes embedded data. Next, the watermarked image is printed on a card substrate. Also provided is an identification card manufacturing system that is adapted to implement the above-described method.

The present application claims priority to U.S. provisional patent application Serial No. 60/365,732, filed Mar. 19, 2002 and entitled “METHOD AND APPARATUS FOR PRINTING ELECTRONIC WATERMARKED SECURE IDENTIFICATION CARD”.

### FIELD OF THE INVENTION

The present invention generally relates to identification card production and, more particularly, to methods and systems for providing security from identification card counterfeiting.

### BACKGROUND OF THE INVENTION

Identification cards are commonly used as a vehicle for identifying the bearer of the card (e.g., driver's licenses), for access control, and other purposes. These identification cards are produced using identification card manufacturing systems, such as those produced by Fargo Electronics, Inc. of Eden Prairie, Minn. Identification card manufacturing systems generally include a computer, at least one card manufacturing application running on the computer, and at least one identification card manufacturing device such as an identification card printer or laminator.

In the case of an identification card printer, the card manufacturing application can combine textual and graphical information to form a print job corresponding to a primary image that is to be printed by the identification card printer on a card substrate. The print job can then be processed by the identification card printer by printing the primary image to the card substrate using a print mechanism. A laminator can then apply an overlaminate material to the card to protect the printed image.

Security from counterfeiting of identification cards is in high demand. One method of fighting counterfeiters is to apply an overlaminate to the cards that includes a custom security marking, such as a hologram. Unfortunately, such security markings that are visible to the naked eye place a would-be counterfeiter on notice of its existence. Accordingly, a counterfeiter can overcome such security markings by either gaining access to the custom overlaminate supply or by reproducing the security mark.

### SUMMARY OF THE INVENTION

The present invention generally provides security from identification card counterfeiting. One aspect of the invention is directed to a method of processing a primary print job corresponding to a primary image using an identification card manufacturing system. In the method, a watermarked image is generated that includes a combination of the primary image and a watermark image. The watermark image includes embedded data. Next, the watermarked image is printed on a card substrate.

Another aspect of the invention is directed to an identification card manufacturing system that is configured to implement the above-described method. The system generally includes an identification card printer, memory, and a print job generating application. The print job generating application is configured to combine a watermark image and a primary image to form a print job for a watermarked image. The identification card printer is configured to process the print job by printing the watermarked image on a card substrate.

### BRIEF DESCRIPTION OF THE DRAWINGS

FIGS. 1 and 2 are simplified diagrams of an identification card manufacturing system in accordance with embodiments of the invention.

FIG. 3 is a flowchart illustrating a method of processing a print job in accordance with embodiments of the invention.

FIG. 4 is a flowchart illustrating a method of generating a watermarked image in accordance with embodiments of the invention.

FIG. 5 is a simplified diagram illustrating the generation of a watermarked image in accordance with embodiments of the invention.

FIG. 6 is a flowchart illustrating a method of verifying a printed watermarked image in accordance with an embodiment of the invention.

### DETAILED DESCRIPTION OF THE PREFERRED EMBODIMENTS

The present invention provides security from identification card counterfeiting. In general, a primary image that is conventionally printed directly to a card substrate by an identification card manufacturing system is modified to include a watermark image that can be undetectable to the naked eye. The watermark image includes, or is representative of, data that can then be used to verify the validity of the identification card and provide other information about the origin of the card, to provide security from counterfeiting.

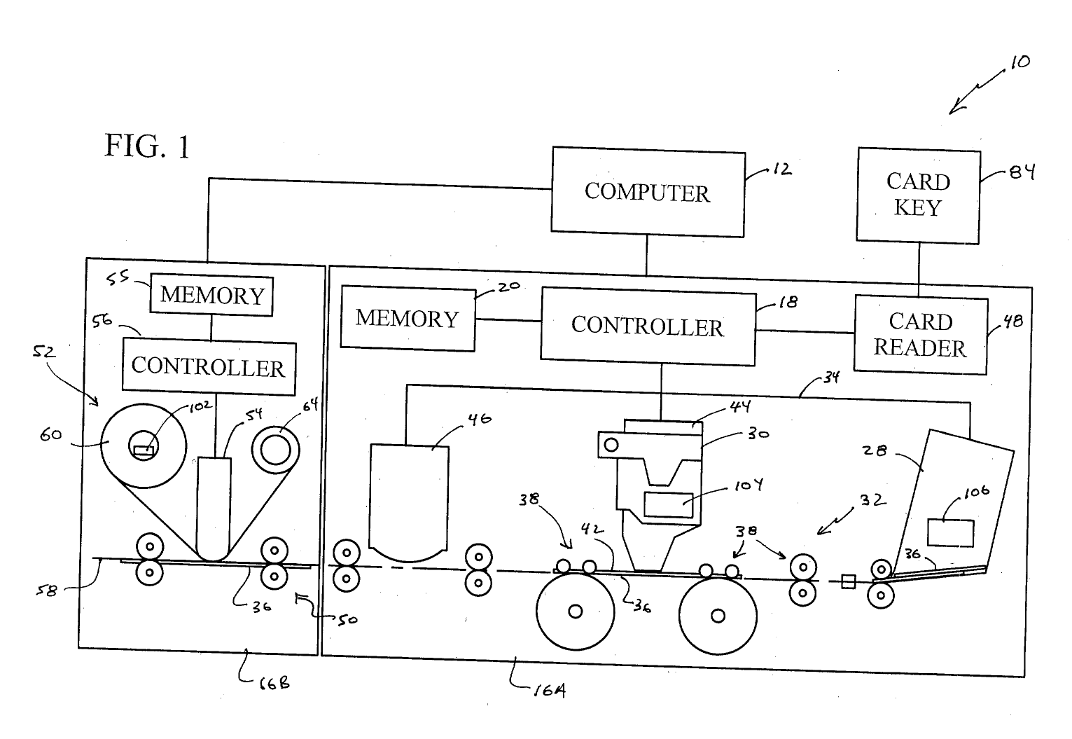

FIG. 1 is a schematic diagram of an example of an identification card manufacturing system 10, in accordance with embodiments of the invention. FIG. 2 is a simplified block diagram illustrating the locations and contents of various memory resources of system 10, in accordance with embodiments of the invention. System 10 generally includes a computer 12 having memory 14. System 10 also includes at least one identification card manufacturing device 16 that can include a controller 18, memory 20, and one or more supplies 22. Device 16 is generally configured to produce an identification card in accordance with instructions from a print job produced by a print job generating application and driver software 24 contained in memory 14 of computer 12. Alternatively, controller 18 of device 16 can be a microcomputer that is configured to execute a print job generating application 26 stored in memory 20 to thereby eliminate the need for computer 12.

Identification card manufacturing device 16 includes an identification card printer 16A and can also include a laminator 16B, as shown in FIG. 1. Although printer 16A and laminator 16B are depicted as separate components, they could be formed as a single identification card manufacturing device 16. Card flippers, data encoders, displays, input devices and other identification card manufacturing components can also be included in system 10.

Identification card printer 16A can include a card supply 28, a print mechanism 30, and a card transport mechanism 32, which are controlled by a controller 18 through a Universal Serial Bus (USB) 34 or other suitable communication bus. Identification card printer 16A also includes memory 20 that is accessible by controller 18. Card supply 28 can be a card cartridge (shown) or a card hopper configured to hold a stack of cards 36. Card transport mechanism 32 can include a plurality of feed rollers 38 that operated to deliver individual card substrates 36 from card supply 28 along a print path 40 to print mechanism 30 for printing an image on a surface 42 of the card, as illustrated in FIG. 1. Print mechanism 30 includes a print supply 44, which can be a thermal print ribbon when print mechanism 30 is a thermal print head, or an ink supply when print mechanism 30 is an ink jet print head. Identification card printer 16A can also include a card scanner 46 and a card reader 48, the uses for which will be discussed below.

Identification card laminator 16B generally includes a card transport mechanism 50 that receives individual cards 36, a laminator supply 52, a laminating mechanism 54, and a memory 55. The components of laminator 16B are controlled by a laminator controller 56. Alternatively, a single controller, such as printer controller 18, can be configured to control the components of both the printer 16A and the laminator 16B. Cards 36 are fed by card transport mechanism 32 along a lamination path 58 to laminating mechanism 54. Laminator supply 52 includes a supply roll 60 of overlaminate material that is fed between a transported card 36 and the laminating mechanism 54 and to a take-up roll 64. The laminating mechanism 54 applies heat to the overlaminate material, which causes a portion of the overlaminate material to adhere to printed surface 42 of the card 36.

Identification card printer 16A and laminator 16B can be used to form conventional identification cards through the processing of a primary print job that is generated by print job generating application. Here, the print job defines a primary image that is to be printed using identification card printer 16A. The primary image can include text, graphics and photos. The print job is communicated to the printer controller 18 in accordance with printer driver software. The printer controller 18 controls the operation of the card transport mechanism 32 and print mechanism 30 to print the primary image to a surface 42 of the card substrate 36. The card substrate can then be laminated using laminator 16B to protect the printed surface 42.

As discussed above, the present invention provides improved security from identification card counterfeiting by means of adding a watermark to the primary image. The watermark contains data that can be used to authenticate the identification card, establish its origin, or provide additional information.

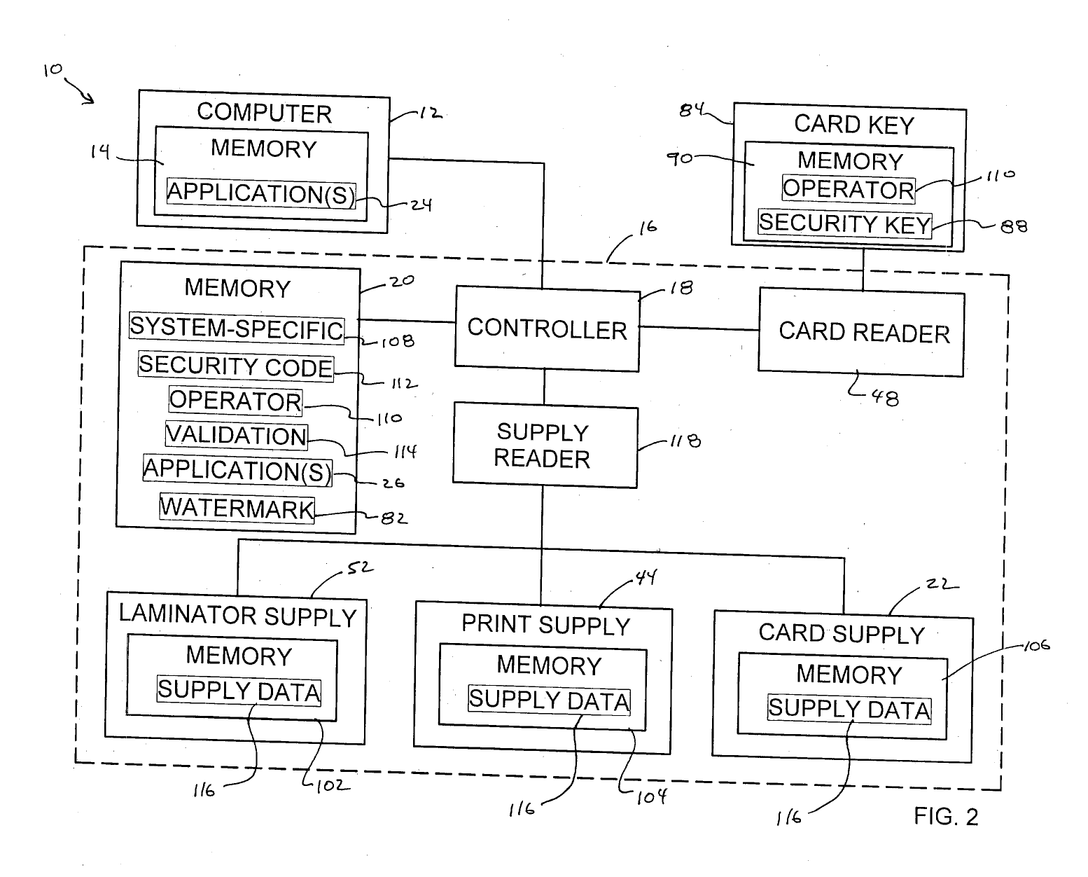

One aspect of the invention is directed to a method of processing a primary print job corresponding to a primary image using an identification card manufacturing system, which is illustrated in the flowchart of FIG. 3. At step 70 a watermarked image is generated that comprises a combination of the primary image and a watermark image that includes embedded data. Next, the watermarked image is printed on a card substrate, at step 72, using print mechanism 30 of printer 16A. This results in the formation of an identification card that includes the printed watermarked image.

The watermark contained in the watermarked image is preferably undetectable by the naked eye. Alternatively, the watermark can be made somewhat detectable to the naked eye to provide security from counterfeiting in a manner similar to overlaminate security markings. The data embedded in the watermark can be extracted using a scanner and appropriate software. The extracted data can then be used, for example, to authenticate the card or determine the origin of the card (i.e., identify the system used to create it and/or the issuer of the card).

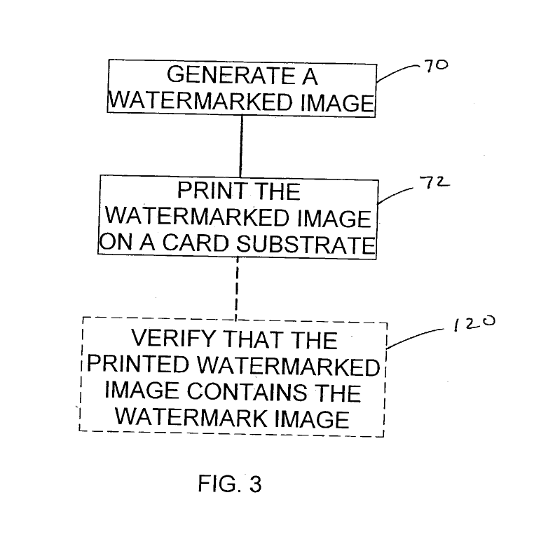

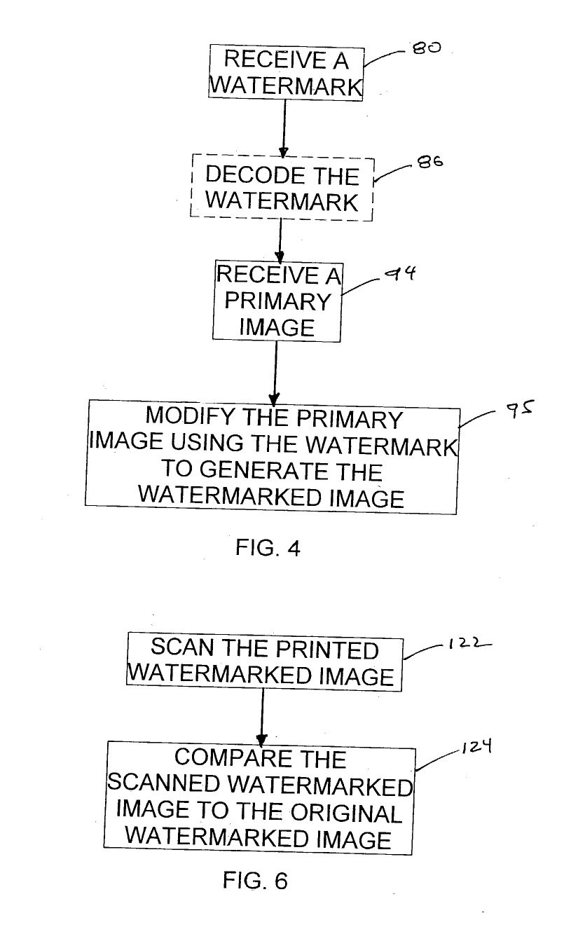

There are several ways of performing the step of generating the watermarked image. In accordance with one embodiment of the invention, the watermarked image is generated in accordance with the flowchart of FIG. 4 and the simplified diagram of FIG. 5. At step 80 of the method, the watermark image 82 or the watermark image data that defines the watermark image (hereinafter referred to as “watermark”), is received by print job generating application 24. The watermark 82 can be stored in memory 20 of the device 16, memory of the removable card key 84, memory 14 of computer 12 (FIG. 2), or a remote database (not shown). If the watermark 82 is encoded or encrypted, it can be decoded or decrypted as indicated at step 86 using, for example, a security key 88 contained in memory 90 of removable card key 84. The print job generating application also receives a primary image 92 or primary image data that defines the primary image (hereinafter referred to as “primary image”), at step 94. Finally, at step 95, the print job generating application 24 modifies the primary image 92 in a predefined manner using the watermark 82 and generates a watermarked image 96 or watermarked image data representing the watermarked image (hereinafter referred to as “watermarked image”).

As mentioned above, the print job generating application 24 can be stored in memory 14 of computer 12, or memory 20 of the device 16. Print job generating application 24 can generate a primary print job corresponding to the primary image 92 or receive the primary print job from another application.

In accordance with another embodiment of the invention, the watermark 82 is generated by a watermark generating application 98 using data 100, as illustrated in FIG. 5. Some of the data 100 is embedded within watermark 82 generated by watermark generating application 98 in accordance with a predefined algorithm. The watermark generating application 98 can be contained in memory 14 of computer 12, or in memory 20 of device 16, of system 10, as indicated at 26 of FIG. 2. Watermark 82 can then be provided to the print job generating application 24 as discussed above to combine it with the primary image 92 to form the watermarked image 96. Alternatively, print job generating application 24 can include watermark generating application 98.

Data 100 used to generate watermark 82 can be stored in memory of identification card manufacturing system 10 such as memory 14 of computer 12, memory 90 of a removable card key 84 that can be read by card reader 48, memory 20 of identification card manufacturing device 16, and/or a supply memory such as laminator supply memory 102, print supply memory 104, and card supply memory 106. Data 100 preferably includes system-specific information 108 relating to system 10, operator information 110 relating to an operator of the system 10 or an issuer of the identification card, a security code 112, and/or validation information 114. The system-specific information 108, operator information 110, or security code 112 is preferably unique to the system 10 and can be used to trace back a produced card to the system that generated it. The security code 112 and the validation information 114 can be used to verify that a produced card having the printed watermarked image 96 is a valid card.

Data 100 can also include additional information, such as a company logo, a company address, a date the card was produced, and other information. Security code 112 also represents other types of security information, such as access control data. Such access control data can be extracted from the watermarked image of the identification card and used to determine whether the card holder is authorized to access a particular area.

The system-specific information 108 can include unique information that identifies system 10 and its components, such as devices 16, supplies 28, 44 and 52, and applications 24 and 26 used by the system 10. For example, the system specific data 108 can include unique serial numbers that identify the device 16, a date the device was produced, a manufacturer of the device, or other system-specific data. Additionally, the system-specific information 108 can include general information about the system 10 such as the type of devices 16 (e.g., printer or laminator) that form it.

The system-specific information 108 can also include supply data 116 contained in memories of the supplies. The supply data 16 can uniquely identify the supplies by serial number, a date when the supply was formed, the type of supply (thermal print ribbon, overlaminate, card), and other information relating to the supply. The supply data 116 can be accessed by controller 18 through a supply reader 118. Supply reader 118 can communicate with the memory of each supply through a direct electrical connection or through a wireless connection using radio frequency (RF) communication methods and provide the data contained therein to controller 18. Controller 18 can analyze the data and/or communicate the data to the appropriate application. Examples of systems including such supplies are described in U.S. Pat. No. 6,386,772 and pending application Ser. Nos. 10/071,554 and 10/372,011, which are assigned to the Assignee of the present invention.

Validation information 114 generally includes information provided by the card that can be read or accessed in a normal fashion, such as printed information, and information stored in a magnetic stripe or memory of the card. Validation information 114 that is embedded in the watermark 82 of the printed watermarked image 96 can be used to verify that the information provide by the card is valid. For example, the embedded data of the watermark 82 can include a birth date of the card holder that matches the visible birth date printed on the card substrate as part of the primary image portion 92 of the watermarked image 96. The printed birth date can be verified as being accurate through a comparison to the watermark's embedded birth date.

It is possible for system 10 to encounter problems during the printing of the watermarked image 96 to the card substrate 36 and/or during the lamination of the card substrate 36. For example, printing errors due to debris on the surface 42 of the card 36 can cause smudging of the printed watermarked image 96, which can render the data embedded in the watermark 82 unreadable. Accordingly, it is desirable to verify that the watermarked image 96 printed to the card substrate 36 sufficiently represents the original or digital form of the watermarked image to ensure that the embedded data of the watermark portion of the printed watermarked image is readable.

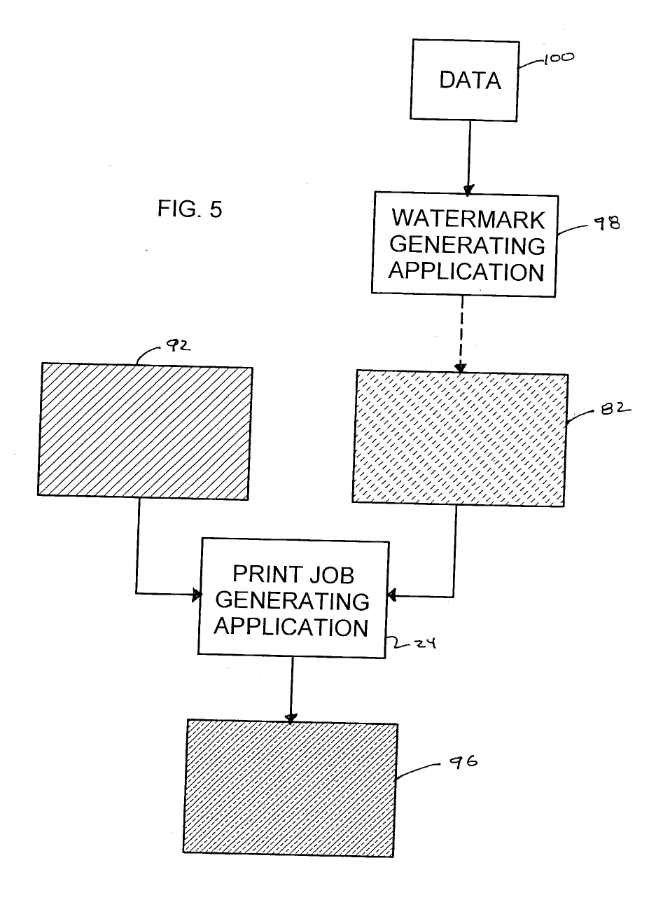

Such a verification process is preferably occurs immediately following the printing step 72, as step 120 of the method illustrated in FIG. 3. This verification step 120 can be performed in accordance with the flowchart illustrated in FIG. 6. At step 122, the watermarked image 96 printed on the card substrate 36 is scanned by an optical scanner, such scanner 46 shown in FIG. 1. Scanner 46 can be a component of identification card printer 16A as shown, a component of laminator 16B, or a separate device of system 10. Scanner 46 produces a scanned watermarked image or data that is compared to the original watermarked image at step 124. The printed watermarked image is deemed to be acceptable when the data embedded in the watermark portion of the scanned watermarked image matches the data that the watermark 82 was intended to represent. In this manner, the printed watermarked image is determined to contain the desired watermark. In the event that it is determined that the printed watermarked image is unacceptable, the card can be placed in a reject hopper to prevent its use.

Although the present invention has been described with reference to preferred embodiments, workers skilled in the art will recognize that changes may be made in form and detail without departing from the spirit and scope of the invention.

What is claimed is:

1. A method of processing a primary print job corresponding to a primary image using an identification card manufacturing system comprising steps of:
a) generating a watermarked image comprising a combination of the primary image and a watermark image, the watermark image having embedded data; and
b) printing the watermarked image on a card substrate.

2. The method of claim 1, wherein the embedded data includes information corresponding to the identification card manufacturing system, an operator of the system, a security code, access control data, and/or validation information.

3. The method of claim 2, wherein the information corresponding to the identification card manufacturing system includes information uniquely identifying an identification card printer, printer supplies, a laminator, and/or laminator supplies.

4. The method of claim 1, wherein:
the watermark image is defined by watermark image data;
the primary image is defined by primary image data; and
the generating step a) includes modifying the primary image data using the watermark image data to form watermarked image data representing the watermarked image.

5. The method of claim 1, wherein the generating step a) includes:
a)1) receiving a watermark image;
a)2) receiving a primary image; and
a)3) combining the watermark image and the primary image to generate the watermarked image.

6. The method of claim 5, wherein the watermark image is received from memory of an identification card printer of the identification card manufacturing system.

7. The method of claim 1, wherein the generating step a) includes:
a)1) receiving watermark image data defining the watermark image;
a)2) receiving primary image data defining the primary image; and
a)3) modifying the primary image data using the watermark image data to form watermarked image data representing the watermarked image.

8. The method of claim 1, wherein:
the watermark image is defined by watermark image data and the primary image is defined by primary image data; and
the generating step a) includes:
a)1) receiving encrypted or encoded watermark image data;
a)2) decrypting or decoding the encrypted or encoded watermark image data to obtain the watermark image data; and
a)3) modifying the primary image data using the watermark image data to form watermarked image data representing the watermarked image.

9. The method of claim 1, including c) verifying that the printed watermarked image includes the watermark image.

10. The method of claim 1, including c) verifying that the printed watermarked image sufficiently represents the generated watermarked image.

11. The method of claim 10, wherein:
the watermarked image is defined by watermarked image data; and the verifying step c) includes:
c)1) scanning the printed watermarked image to thereby produce scanned watermarked image data; and
c)2) comparing the scanned watermarked image data to the watermarked image data;
wherein the printed watermarked image sufficiently represents the watermarked image when the scanned watermarked image data substantially matches the watermarked image data.

12. An identification card manufacturing system comprising:
an identification card printer;
memory containing data that includes information corresponding to the identification card manufacturing system, an operator of the system, a security code, and/or validation information;
an image processing application configured to generate a watermark image in which the data is embedded; and
a print job generating application combining the watermark image and a primary image to form a print job for a watermarked image;
wherein the printer is configured to process the print job by printing the watermarked image on a card substrate.

13. The system of claim 12, wherein the memory is a component of a removable security card.

14. The system of claim 12, wherein the identification card printer includes the memory.

15. The system of claim 12, wherein the identification card printer includes:
a card supply;
a card transport mechanism configured to transport individual cards from the card supply along a print path;
a printhead for printing on a surface of a card delivered by the card transport mechanism; and
a printer controller configured to control the card transport mechanism and printhead in accordance with a print job received from the print job generating application.

16. The system of claim 14, wherein the print job generating application is stored in the memory.

17. The system of claim 12, including a card scanner configured to scan a card having a printed watermarked image and produce scanned watermarked image data.

18. An identification card manufacturing system comprising:
an identification card printer;
memory containing a watermark image that includes embedded data; and
a print job generating application combining the watermark image and a primary image to form a print job for a watermarked image;
wherein the printer is configured to process the print job by printing the watermarked image on a card substrate.

19. The system of claim 18, wherein the memory is a component of a removable security card.

20. The system of claim 18, wherein the identification card printer includes the memory.

21. The system of claim 18, wherein the identification card printer includes:
a card supply;
a card transport mechanism configured to transport individual cards from the card supply along a print path;
a printhead for printing on a surface of cards delivered by the card transport mechanism; and
a printer controller configured to control the card transport mechanism and printhead in accordance with a print job received from the print job generating application.

22. The system of claim 18, wherein the print job generating application is stored in the memory.

23. The system of claim 18, including a card scanner configured to scan a card having a printed watermarked image and produce scanned watermarked image data.

24. The system of claim 18, wherein the embedded data includes information corresponding to the identification card manufacturing system, an operator of the system, a security code, access control data, and/or validation information.

25. An identification card comprising:
a card substrate; and
a watermarked image printed on a surface of the card substrate, the watermarked image including a primary image and a watermark image embedded in the primary image, the watermark image containing embedded data.

26. The identification card of claim 25, wherein the embedded data includes information corresponding to the system used to manufacture the card, an operator of said system, a security code, access control data, and/or validation information.
